(19) United States
(12) Patent Application Publication
(10) Pub. No.: US 2012/0300320 A1
(43) Pub. Date: Nov. 29, 2012

(54) Method for Manufacturing Lens Unit, Imaging Device, Method for Manufacturing Mold, Mold For Molding, and Method for Molding Glass Lens Array

(76) Inventors: Hiroyuki Matsuda, Sagamihara-shi (JP); Takashi Ibi, Toyonaka-shi (JP); Kenichi Iwaida, Hachioji-shi (JP); Shunichi Hayamizu, Amagasaki-shi (JP)

(21) Appl. No.: 13/575,839

(22) PCT Filed: Feb. 1, 2011
(86) PCT No.: PCT/JP2011/051993

§ 371 Date: Jul. 27, 2012

(30) Foreign Application Priority Data
Feb. 1, 2010 (JP) 2010-020286

(51) Int. Cl. C03B 19/00; C03C 27/10; B32B 38/04; C03B 7/14; G02B 7/02; B32B 37/24

(52) U.S. Cl. 359/811; 156/242; 65/207; 65/66

(57) ABSTRACT

A method for manufacturing a lens unit including the steps of: forming a first lens array, having plural first lens sections and first reference surfaces formed in a predetermined arrangement, via glass forming by arranging a glass material between a first assembled molds and by clamping the molds; forming a second lens array, having plural second lens sections and second reference surfaces formed in a predetermined arrangement, via glass forming by arranging a glass material between a second assembled molds and by clamping the molds; forming a third lens array by stacking and bonding the first and second lens arrays so that an optical axis of each lens section of the first and second lens arrays coincide, by using the first and second reference surfaces; and cutting the third lens array into each lens unit which includes at least each one of the first and the second lens sections.

### TECHNICAL FIELD

The present invention relates to a method for manufacturing a lens unit, an imaging device, a method for manufacturing a mold, a mold for molding, and a method for molding a glass lens array.

### BACKGROUND TECHNOLOGY

A compact and extremely thin imaging device (hereinafter, referred to also as a “camera module”) is being used for portable terminals such as mobile phones and PDA (Persona Digital Assistant) which are compact and thin electronic devices. As image sensors used in these imaging devices, solid-state imaging elements such as CCD-type image sensors and CMOS-type image sensors are known. Over recent years, the increase of pixels in imaging elements has progressed, and resolution and performance have been enhanced. Further, in imaging lenses to form a subject image on these imaging elements, in response to miniaturization of imaging elements, compactness is being required, and this requirement tends to grow year by year.

As such an imaging lens used for an imaging device built into a portable terminal, an optical system consisting of a plastic lens is known. In the meantime, a technique has been suggested in which a large amount of plastic lens elements are simultaneously formed via a replica method on a wafer in a size of several inches, and after the wafer is joined with a sensor wafer, the joined body is cut to produce a large amount of camera modules (refer to Patent Document 1).

### PRIOR ART DOCUMENT

### Patent Document

Patent Document 1: Unexamined Japanese Patent Application Publication No. 2006-323365

### SUMMARY OF THE INVENTION

### Problems to be Solved by the Invention

However, changes in the refractive index with respect to changes in temperature are high in case of plastics, and therefore, in order to form an image of high image quality regardless of imaging conditions, it is preferred to use a glass lens which is capable of exhibiting stable optical properties. On the other hand, in the case of a conventional method for manufacturing a glass lens, a plurality of lenses is molded individually by glass, and then combined, so that there is a problem that the method is time consuming and not suitable for mass-production.

Compared to this, it can be considered that glass lenses are molded in the form of an array on a wafer in a similar fashion to the above-mentioned plastic lens. However in this case, new technological issues arise, which are not assumed in the formation of plastic lenses on a wafer. One of the problems is a problem in deviation of optical axes of either side of a lens in the entire part of the lens array. In the case of a plastic lens, a lens section is formed of a plastic on one surface through the intermediary of a glass substrate, and then, a lens surface is formed of a plastic on the other surface so that a lens array of double-sided lens is formed. In this case, for the deviation of optical axes of either side of each lens a structure can be obtained in which the optical axis of one surface of the lens section and the optical axis of the other surface of the lens section are matched. Compared to this, because both surfaces of lens section are molded collectively at one time in the case of glass lens array, and therefore, it is necessary to carry out a positional adjustment of the mold for molding double-sided lens arrays in advance prior to molding, and thus surface shape precision and positional accuracy of the mold is required. In this regard, the same shall apply to the case of a molding of a single glass lens, however in the case of a lens array which are formed by molding a plurality of less sections collectively, it is necessary to consider not only the position between double-sided lenses, but also deviation of position between adjacent lenses at the same time, thereby causing an extreme difficulty. Therefore, while ingenuity is necessary for obtaining aforementioned high shape precision and positional accuracy easily, a new requirement is arising such that the state of a mold configuration, in which the aforementioned high shape precision and positional accuracy have been once obtained, is preferred to be maintained as much as possible.

The present invention has been achieved in view of these problems of conventional technology in prior, and an object thereof is to provide a method for manufacturing a lens unit, an imaging device, a method for manufacturing a mold, a mold for molding, and a method for molding a glass lens any for mass-producing a lens unit suitable for an imaging device by using a glass material readily with high accuracy.

### Means to Solve the Problems

A method for manufacturing a lens unit according to a first embodiment of the present invention, the method including the steps of: forming a first glass lens array including a plurality of first lens sections and first positioning reference surfaces, having been formed in a predetermined arrangement, via glass forming by arranging a glass material between a first set of assembled molds and by clamping the first set of assembled molds; forming a second glass lens array including a plurality of second lens sections and second positioning reference surfaces, having been formed in a predetermined arrangement, via glass forming by arranging a glass material between a second set of assembled molds and by clamping the second set of assembled molds; forming a third glass lens array by stacking and bonding the aforementioned first glass lens array and the aforementioned second glass array to each other in such a manner that an optical axis of each lens section of the aforementioned first glass lens array and the aforementioned second glass lens array coincide, by using the aforementioned first positioning reference surface and the aforementioned second positioning reference surface; and cutting the aforementioned third glass lens array in each lens unit which includes at least each one of the aforementioned first lens section and the aforementioned second lens section.

According to the structure, a plurality of the first lens sections and a plurality of the second lens sections can be, by reflecting a state of high precision obtained via positioning of the lens mold, positioned accurately at one time by using the aforementioned first positioning reference surface and the aforementioned second positioning surface, and further, by bonding together and cutting off, a high precision lens unit can be mass-produced. “Predetermined arrangement” represents a case of “n” columns×“m” rows alignment, circular alignment, or the like.

Preferably, the aforementioned first positioning reference surface is formed parallel to an optical axis of the aforementioned first lens section and consists of a first reference surface section and a second reference surface section in mutually intersecting directions from each other, and the aforementioned second positioning reference surface is formed parallel to an optical axis of the aforementioned second lens section and consists of a third reference surface section and a fourth reference surface section in mutually intersecting directions. In this way, it is possible to make the optical axes of the plurality of the first lens sections and the plurality of the second lens sections coincide at one time by using the aforementioned first through fourth reference surfaces.

Preferably, the aforementioned first positioning reference surface includes a first inclination reference surface section perpendicular to the optical axis of the aforementioned first lens section; and the aforementioned second positioning reference surface includes a second inclination reference surface section perpendicular to the optical axis of the aforementioned second lens section. In this way, it is possible to make the tilt of the plurality of the first lens sections and the plurality of the second lens sections to match to each other at one time by using the aforementioned first inclination reference surface section and the aforementioned second inclination reference surface section.

Preferably, the step for bonding the aforementioned first glass lens array and the aforementioned second glass array to each other includes a step of in a state in which a biasing force is being applied to the aforementioned first positioning reference surface by placing the aforementioned first glass lens array downwardly in a vertical direction, approximating the aforementioned second glass lens array, which is maintained upwardly in the vertical direction, to the aforementioned second positioning reference surface in a state in which a biasing force is being applied to the aforementioned second positioning reference surface. In this way, it is possible to carry out a high precision positioning of the plurality of the first lens sections and the plurality of the second lens sections.

Preferably, the aforementioned first glass lens array includes a first mark indicating the aforementioned first positioning reference surface, and the aforementioned second glass lens array includes a second mark indicating the aforementioned second positioning reference surface. In this way, it is possible to know the direction in which the aforementioned glass lens array is biased.

Preferably, the step for forming at least either one of the aforementioned first glass lens array or the aforementioned second glass array includes a step of carrying out formation after causing a molten glass material to be dropped from above onto a lower mold of an assembled mold of at least either one of the aforementioned first set of assembled mold or the aforementioned second set of assembled mold. In this way, it is possible to readily form a lens section in which flange thickness is different from axial thickness. However, a plurality of lens sections may be formed at one time by using a plate-shape glass material.

An imaging device, according to a second embodiment of the present invention, includes: a lens unit manufactured by the manufacturing method described above; a lens frame which encloses the aforementioned lens unit, wherein a lens section of the aforementioned lens unit or a surface formed by extending the lens section is positioned with respect to the lens frame.

In this way, without using a cutting surface of which the accuracy tends to become comparatively rough, the lens unit can be attached with a high degree of accuracy.

A method for manufacturing a first upper mold, a first lower mold, a second upper mold, and a second lower mold, according to a third embodiment of the present invention, the method using the first upper mold including: a first upper mold sleeve into which a plurality of cylindrical through-holes is formed, and includes a first side surface portion parallel to the through-holes; and a plurality of first upper mold core members each of which is inserted into the aforementioned through holes, and each of which includes a transferring surface at one end for forming a lens section; the method also using the first lower mold including a first lower mold sleeve into which a plurality of cylindrical through holes is formed, and includes a second side surface portion parallel to the through-holes; and a plurality of first lower mold core members each of which is inserted into the aforementioned through-holes, and each of which includes a transferring surface at one end for forming a lens section; the method further using the second upper mold including: a second lower mold sleeve into which a plurality of cylindrical through-holes is formed, and includes a third side surface portion parallel to the through-holes; and a plurality of second upper mold core members each of which is inserted into the aforementioned through-holes, and each of which includes a transferring surface at one end for forming a lens section; the method still further using the second lower mold including: a second lower mold sleeve into which a plurality of cylindrical through-holes is formed, and includes a fourth side surface portion parallel to the through-holes; and a plurality of second lower mold core members each of which is inserted into the aforementioned through-holes, and each of which includes a transferring surface at one end for forming a lens section; forming a first glass lens array in which a plurality of glass lens sections and flange sections are integrally formed by arranging a glass material between the aforementioned first upper mold and the aforementioned first lower mold and by clamping the first upper and lower molds; forming a second glass lens array in which a plurality of glass lens sections and flange sections are integrally formed by arranging a glass material between the aforementioned second upper mold and the aforementioned second lower mold and by clamping the second upper and lower molds; forming a glass lens array layered body by stacking and bonding the aforementioned first glass lens array and the aforementioned second glass lens array, the method for manufacturing the aforementioned first upper mold, the aforementioned first lower mold, the aforementioned second upper mold, and the aforementioned second lower mold, the method including steps of stacking the aforementioned first upper mold, the aforementioned first lower mold, the aforementioned second upper mold, and the aforementioned second lower mold; and processing each through-hole of the aforementioned first upper mold, the aforementioned first lower mold, the aforementioned second upper mold, and the aforementioned second lower mold simultaneously via a machining process.

According to the present invention, the first lens section and the second lens section can be processed with a high degree of accuracy such that distance between axes of the plurality of first lens sections to be formed by using the aforementioned first upper mold core members and first lower mold core members of the first upper mold and first lower mold, and distance between axes of the plurality of second lens sections to be formed by using the aforementioned second upper mold core members and second lower mold core members of the second upper mold and second lower mold coincide, and therefore, it becomes easier to coincide the optical axes of the plurality of first lens sections and the plurality of second lens sections at the same time, thus this can contribute to mass-production of high precision lens units.

Further, preferably, the formation and processing of the aforementioned first side surface portion through fourth side surface portion are carried out via a machining process together with the simultaneous processing of the aforementioned through-holes, and after the simultaneous processing of the aforementioned through-holes, preferably the aforementioned first side surface portion through fourth side surface portion are processed simultaneously via a machining process so that accurate positioning becomes possible by using the first side surface portion through the fourth side surface portion.

A mold for molding according to a fourth embodiment of the present invention is a mold for forming a glass lens array in which a plurality of lens sections and flange sections are integrally formed, the mold for molding includes: an upper mold arranged above in a vertical direction including: an upper mold sleeve into which a plurality of cylindrical through-holes is formed; and a plurality of upper mold core members each of which is inserted into the aforementioned plurality of through-holes, and each of which includes a transferring surface at one end for forming a lens section; and a lower mold arranged below in a vertical direction in which a transferring surface faces the aforementioned upper mold, wherein a glass lens array, in which a plurality of glass lens sections and flange sections are integrally formed, is formed by arranging a glass material between the aforementioned upper mold and the aforementioned lower mold and by clamping the aforementioned upper mold and the aforementioned lower mold.

According to this structure, because deviation of optical axes of either side of the lens and deviation of axes between adjacent lens sections can be reduced in a glass lens array in which a plurality of lens sections having lens surfaces on either side is formed integrally, it is possible to form a high-precision glass lens array, and therefore, it becomes possible to mass-produce high-precision glass lens arrays.

Also, preferably, the diameter of through-hole of the aforementioned upper mold is constituted so as to have an identical diameter entirely from an upper side to a lower side, and includes a holding section for holding the aforementioned upper mold core members in a vertical direction against gravity with respect to the aforementioned upper mold sleeve. In such a way, it is possible to control to prevent breakage of the upper mold core member, and also prevent inadvertent falling of the upper mold core member.

Preferably, the aforementioned holding section is a magnet, and at least a part of the aforementioned upper mold core members is composed of a magnetic material. However, as a means of the aforementioned holding means, means such as vacuuming or the like may be used.

Also, preferably, the aforementioned lower mold includes: a lower mold sleeve into which a cylindrical through-hole is formed; and a plurality of lower mold core members having a transferring surface at one end for forming a lens section, wherein at least one of the aforementioned upper mold core members or the aforementioned lower mold core members is arranged such that an amount of protrusion is adjustable by using a spacer with respect to at least one of the aforementioned upper old sleeve and the aforementioned lower mold sleeve. In this way, it becomes possible to facilitate control of the amount of protrusion of the core at the time of formation.

A method for molding a glass lens array according to a fifth embodiment of the present invention is a method for molding a glass lens array for molding a glass lens array in which a flange section and a plurality of lens sections are integrally formed by arranging a glass material between an upper mold and a lower mold arranged in a vertical direction and by clamping the aforementioned upper mold and lower mold, the method including the steps of preparing aforementioned lower mold, arranged below in a vertical direction, having a plurality of transferring surfaces corresponding to lens surfaces of the aforementioned plurality of lens sections; dropping simultaneously from above a necessary amount of molten glass to form at least two of the aforementioned lens sections onto the aforementioned lower mold; and arranging the aforementioned upper mold with respect to the aforementioned lower mold onto which the molten glass has been dropped, and clamping the aforementioned upper mold and the aforementioned lower mold.

In such a way, even in a case in which a plurality of lens sections is integrally formed at one time, differences in shape and optical properties of each lens section hardly appear, and therefore, it becomes possible to form a large number of glass lenses with a simple structure.

Further, preferably, the molten glass to be dropped in the aforementioned step is dropped onto a position having an equal distance from a plurality of transferring surfaces for forming the aforementioned lens sections. In this way, the molten glass fills each lens section evenly at the time of formation so that a large amount of high quality lenses which exhibit a smaller dispersion in properties can be obtained at one time.

### Effects of the Invention

According to the present invention, it is possible to provide a method for manufacturing a lens unit, an imaging device, a method for manufacturing a mold, a mold for molding, and a method for forming a glass lens array, for accurately and readily mass-producing a lens unit suitable for an imaging device by using a glass material.

### BRIEF DESCRIPTION OF THE DRAWINGS

FIG. 1 is a sectional view of a part of a mold for molding used for an embodiment.

FIG. 2 is a perspective view of a mold for molding used for an embodiment.

FIG. 3 is a bottom view of an upper mold.

FIG. 4 is a top view of a lower mold.

FIG. 5 is a diagram illustrating a state in which an upper mold 12 and a lower mold 22, and an upper mold 12′ and a lower mold 22′, before attaching to a mold holder, are arranged in series so as to process at one time.

FIG. 6 is a diagram illustrating a molding process using a mold.

FIG. 7 is a diagram illustrating a molding process using a mold.

FIG. 8 is a diagram illustrating a molding process using a mold.

FIG. 9 is a perspective view of a front side of a first glass lens array IM1.

FIG. 10 is a perspective view of a reverse side of the first glass lens array IM1.

FIG. 11 is a perspective view of a front side of a second glass lens array IM2.

FIG. 12 is a perspective view of a reverse side of the second glass lens array IM2.

FIG. 13 is a diagram illustrating a part of a jig JZ which holds the reverse side of the first glass lens array IM1 or the second glass lens array IM2.

FIG. 14 is a diagram illustrating a process to form a third glass lens array IM3.

FIG. 15 is a diagram illustrating a process to form the third glass lens array IM3.

FIG. 16 is a diagram illustrating a process to form the third glass lens array IM3.

FIG. 17 is a perspective view of a lens unit obtained from the third glass lens array IM3.

FIG. 18 is a perspective view of an imaging device 50 using a lens unit according to an embodiment.

FIG. 19 is a cross-sectional view of the configuration of FIG. 18 cut along the arrow XIX-XIX line and viewed in the direction of the arrows.

FIGS. 20a and 20b are each a diagram illustrating a state in which the imaging device 50 is incorporated in a cellular phone 100 which serves as a mobile terminal representing a digital device.

FIG. 21 is a control block diagram of the cellular phone 100.

### DESCRIPTION OF THE PREFERRED EMBODIMENTS

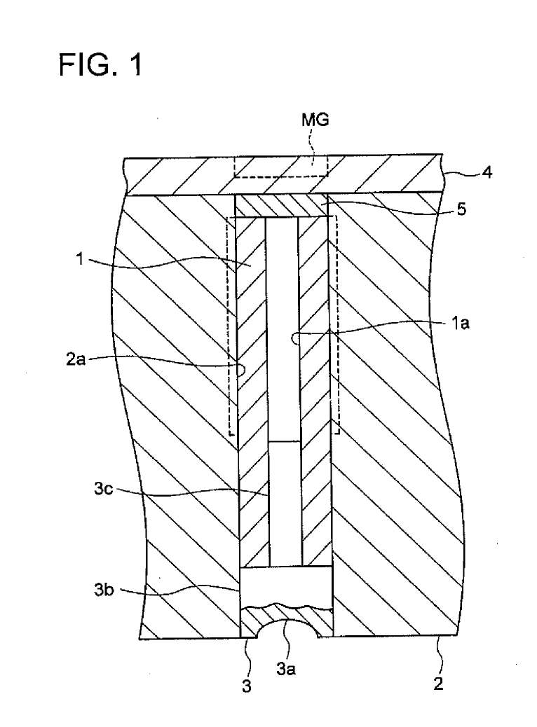

Hereinafter, preferred embodiments according to the present invention will be described with reference to the drawings. FIG. 1 illustrates a sectional view of a part of an injection mold used for this embodiment. It is to be noted that the up-down direction is defined as the same direction as a vertical direction in FIG. 1.

As illustrated in FIG. 1, a hollow cylindrical core supporting member 1 is a hollow cylindrical member having equal outer diameter throughout the entire length of it, and includes a through-hole 1a in the axial direction, and the material is composed of STAVAX (pre-hardened steel) which is a magnetic substance. The coefficient of thermal expansion of STAVAX is 1.2×10⁻⁵/K.

Meanwhile, a mold sleeve 2 includes a cylindrical aperture 2a Inside the aperture 2a, the core supporting member 1 is engaged. A core 3, which is made of a ceramic, includes a head section 3b having a molding transfer surface 3a formed on an end face, and a shaft section 3c which is connected to the head section 3b. By inserting the shaft section 3c which has a cylindrical shape into the through-hole 1a and fixing by a temperature-resistant adhesive agent, the core 3 is fixed to the end portion of the core supporting member 1. It is to be noted that the core 3 and the core supporting member 1 constitute a core member. It is to be noted that the core 3 is composed of material SiC of which the coefficient of thermal expansion is 4.7×10⁻⁵/K.

Here in this embodiment, the core supporting member 1a intervenes between the aperture of the aforementioned mold sleeve and the aforementioned core, and further, materials has been selected in such a manner that the coefficient of thermal expansion of the aforementioned core supporting member is larger than the coefficient of thermal expansion of aforementioned mold sleeve. In such a way, where a level of clearance is provided such that the aforementioned core and the aforementioned core supporting member are easily fitted in the case of normal ambient temperature, the outer diameter of the aforementioned core supporting member expands more than the outer diameter of the aperture of the aforementioned mold sleeve expands due to the thermal expansion so as to eliminate the gap, into which the aforementioned core is engaged, at the time of transfer formation, and therefore, the molding transfer surface formed on the aforementioned core is positioned accurately with respect to the aperture of the aforementioned mold sleeve, whereby a high precision lens can be molded.

Specifically, with respect to the material for a core which includes an optical surface of a mold, there is a case in which the materials which are preferable to use are limited. For example, although SiC is often most suitable as the material of the core, because the coefficient of thermal expansion of SiC is comparatively low, to fill the fitting clearance by utilizing thermal expansion, a material of even lower coefficient of thermal expansion needs to be used as the material of a mold sleeve. However, although there exists a material of which the coefficient of thermal expansion is lower than that of SiC, when considering that the material is practically used for molding, conditions other than the coefficient of thermal expansion need to be considered, thus selection of materials becomes difficult. On the other hand, as the point of view changes, because SiC is only necessary for a molding transfer surface portion, it would not be necessary to use a SiC for a fitting portion. Therefore, by dividing the structure of a pin into a portion which posses functions necessary for optical surface transferring, and a portion which posses functions to fill the fitting clearance by thermal expansion, the problem of axial misalignment can be avoided while using SiC. In this way, while utilizing a mechanism to align by means of thermal expansion, the freedom of choice of the material, which is preferable to use for an optical surface, is expanded, and a mold advantageous for molding can be produced, as being much more preferable.

It is to be noted that the coefficient of thermal expansion of a core supporting member is preferably more than twice the coefficient of thermal expansion of the mold sleeve into which such core supporting member is fixed. According to this structure, both the assurance of a clearance required for fitting and the elimination of the clearance by thermal expansion can be easily provided.

Also, it is preferable that the aforementioned core is adhered to the aforementioned core supporting member. However, the core may be fixed mechanically by a screw or the like.

Further, it is preferable that the outer diameter of the fitting portion of the aforementioned core supporting member is larger than the outermost diameter of the aforementioned core, and at the time of molding, the outer diameter of fitting portion of the aforementioned core supporting member is larger than the outermost diameter of the aforementioned core. According to this structure, the difference between the outer diameter of aforementioned core after thermal expansion and the outer diameter of the aforementioned core supporting member can be reduced, and a clearance between the aperture of the aforementioned mold sleeve and the aforementioned core can be smaller.

Further, it is preferable that the material of the aforementioned mold sleeve is WC, and the material of the aforementioned core supporting member is STAVAX, and the material of the aforementioned core is SiC.

Originally, in a case in which a single lens is molded between molds, because it is comparatively easy to align the optical axes of both of the molds, a common practice is to form a lens molding surface on the mold itself. However, in a case in which a plurality of lens sections is formed collectively as in the embodiment of the present invention, the positional misalignment between not only the lenses on both surface, but also adjacent lenses, and optical axes with respect to corresponding lens surface of those others need to be adjusted accurately, and therefore, because it is difficult to form a high-precision lens molding surface on either side directly on the mold itself, a method is considered in which a two-member construction composed of a core member and a sleeve provided with a through-hole through which the core member is inserted is adopted, and each lens molding surface is formed on each of the core member, and strict alignment of optical axis is adjusted individually within the through-hole. It is to be noted that a bottom plate shall be divided for every core, and a threaded groove is provided on each of the divided bottom plate to screw down a mold sleeve corresponding to each thereof and a disk-shaped spacer so that a positional adjustment of the mold sleeve corresponding to each thereof and the disk-shaped spacer may be carried out individually on each core.

However, in a case in which such two-member construction is arranged for press molding of a glass material, both for a method in which a solid of approximate-shaped of lens such as a preform is used, and a method in which a glass material, having been preliminary melted, is used for molding, a method in which molds are opened in the up and down direction is commonly practiced, and in this latter case in particular, because a molten glass material falls in drops on one of the molding surfaces, it is necessary to have such construction of a mold opening.

Then, because it is more likely that the core member of the upper mold as it is drops off from the aperture, by making the core supporting member 1 be in a shape in which a large diameter portion and a small diameter portion are joined in series as illustrated by a dotted line, and in association with this, by bringing the large diameter portion into contact with a stepped portion which is formed by narrowing the lower part of the aperture 2a, the core supporting member 1 is thereby prevented from falling from the aperture 2a downwardly in a vertical direction. Also at the same time, it becomes possible to control the amount of protrusion of the core 3. However, in this case, the large diameter portion of the core supporting member 1 may collide with a corner of the stepped portion of the aperture 2a when the core supporting member 1 is inserted, which may cause a scratch, or breakage such as a chip of the stepped portion or the like, as a result, a fragment may be stuck in the clearance.

Therefore, in the present embodiment, a configuration is adopted in which the outer circumference of the core supporting member 1 and the inner circumference of the aperture 2a are made to be in a cylindrical configuration having substantially the identical diameter from the upper side to the lower side with an equal diameter with each other, and further, a bottom plate 4 which is composed of a magnet is attached to the upper face of the mold sleeve 2 so as to cover the upper end of the aperture 2a. In this way, with the cylindrical configuration having an identical diameter, control to suppress breakage at the time of insertion is achieved, and also because the core supporting member 1 is composed of a magnetic material, the bottom plate 4, serving as a holding means, attracts the core supporting member 1 inside the aperture 2a upwardly and holds it in a vertical direction against gravity, and therefore, control to prevent an inadvertent fall of the core supporting member 1 at the time of insertion from the lower side is achieved.

Meanwhile, with respect to the amount of intrusion of the core 3, by arranging a disk-shaped spacer 5, having an appropriate thickness, between the upper end of the core supporting member 1 and the bottom plate 4, an intended value can be set. It is to be noted that the entirety of the bottom plate 4 is not necessarily formed of a magnet, and as illustrated by a dotted line, a disk-shaped magnet MG may be attached to non-magnetic bottom plate 4 against the aperture 2a.

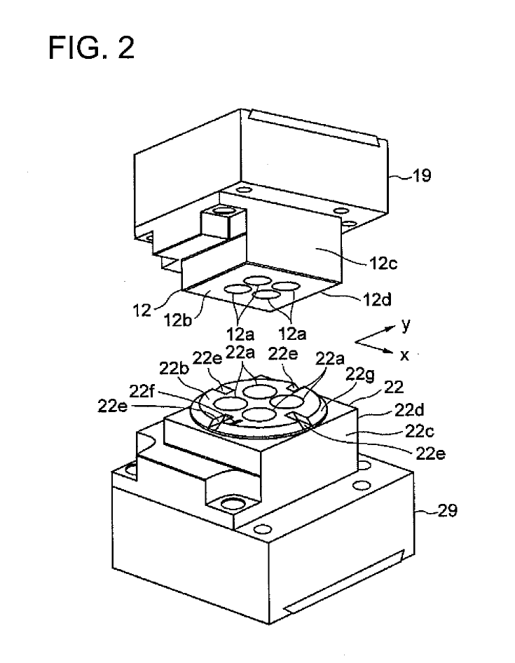

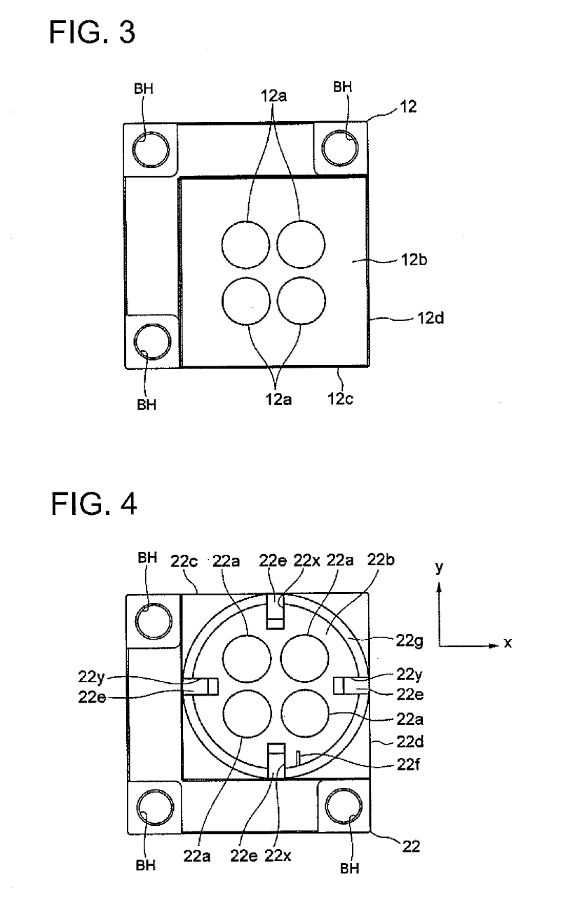

FIG. 2 is a prospective view of the injection mold used for this embodiment. FIG. 3 is a bottom view of an upper mold and FIG. 4 is a top view of a lower mold. In FIG. 2, an upper mold (a first upper mold sleeve) 12, which is fixed to and supported by an upper holder 19 via bolts (not illustrated in the figure) inserted into bolt-holes BH, has a plurality (here, arranged in two lines horizontally and vertically) of cylindrical apertures (through-holes) 12a, a lower surface 12b which is a rectangular-shaped plane extending around the apertures 12a, and reference side surfaces (first side surface portions) 12c and 12d which perpendicularly intersect the lower surface 12b, are also mutually perpendicular. These side surfaces form surfaces parallel to the central axis of the cylindrical through-holes. Core supporting members 11, having constitutions similar to those of the one illustrated in FIG. 1, can be fitted into the apertures 12a. Cores 13 and the core supporting members 11 constitute first upper mold core members.

On the other hand, a lower mold (a first lower mold sleeve) 22, which is fixed to and supported by a lower holder 29 via bolts (not illustrated in the figure) inserted into the bolt-holes BH, has a plurality (here, arranged in two lines horizontally and vertically) of cylindrical apertures (through-holes) 22a, an upper surface 22b which is a circular-shaped plane extending around the apertures 22a, four grooves 22e which extend from outer periphery at a constant interval in a direction between the apertures 22a, a slit-like mark 22f formed adjacent to one of the grooves 22e on the upper surface 22b, and reference side surfaces (second side surface portions) 22c and 22d which perpendicularly intersect the upper surface 22b and also are mutually perpendicular. On the periphery of the upper surface 22b, a tapered portion 22g is formed. Core supporting members 21 can be fitted into the apertures 22a. Cores 23 and the core supporting members 21 constitute first lower mold core members. It is to be noted that, with respect to the grooves 22e, surfaces 22x in x direction and surfaces 22y in y direction are reference surfaces (refer to FIG. 4).

In the present embodiment, in addition to the upper mold 12 and the lower mold 22, an upper mold 12′ and a lower mold 22′, having a similar constitution, are used. It is to be noted that, with respect to the upper mold (a second upper mold) 12′ and the lower mold (a second lower mold) 22′, because these are areas similar to the upper mold 12 and the lower mold 22, explanations are omitted by attaching a dash (′) to the same symbol. However, a first set of assembled mold is a combination of the upper mold 12 and the lower mold 22, a second set of assembled mold is a combination of the upper mold 12′ and the lower mold 22′, the upper mold 12′ is a second upper mold sleeve, reference side surfaces 12c′ and 12d′ of the upper mold 12′ are third side surface portions, cores 13′ and core supporting members 11′ are second upper mold core members, a lower mold 22′ is a second lower mold sleeve, reference side surfaces 22c′ and 22d′ of the lower mold 22′ are fourth side surface portions, and cores 23′ and core supporting members 21′ are second lower mold core members.

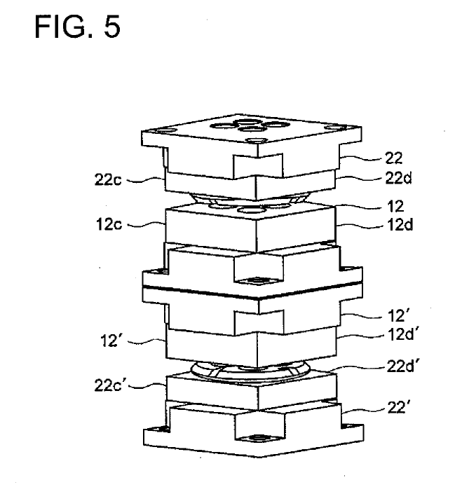

Here, at the time of formation of a lens unit, to be described later, there may occur a problem in regard to the accuracy of the apertures of the upper mold 12 and the lower mold 22, and the upper mold 12′ and the lower mold 22′. Therefore, in the present embodiment, as illustrated in FIG. 5, by using a guide or the like, which is not illustrated, after the lower mold 22 and the upper mold 12, and the upper mold 12′ and the lower mold 22′ are overlapped so that the reference side surfaces 22c, 12c, 12c′ and 22e′ (these are located on the rear surface sides in FIG. 5) are arranged on the same plane, and also the reference side surfaces 22d, 12d, 12d′ and 22d′ (these are located the rear surface sides in FIG. 5) are arranged on the same plane, by using a cutting tool such as a drill or the like, the apertures 22a, 12a, 12a′ and 22a′ are processed at one time. In this way, the coordinates in the x and y directions of each of the four apertures 22a, 12a, 12a′ and 22a′ coincide. Here, a first mold reference surfaces each is the reference side surfaces 12c and 22c, and the reference side surfaces 12d and 22d, which are specific two side surfaces perpendicular to each other, arranged on the same plane as previously described, of the four surfaces which form the side surfaces of each of the upper mold 12 and the lower mold 22, and in a similar fashion, a second mold reference surfaces each is the reference side surfaces 12c′ and 22c′, and the reference side surfaces 12d′ and 22d′, which are a specific two side surfaces of each of the upper mold 12′ and the lower mold 22′.

It is to be noted that, if the accuracy is guaranteed, instead of processing the through-holes simultaneously by using a cutting tool after the upper and lower molds are stacked so that the reference side surfaces are arranged on the same plane, processing of formation of through-holes may be carried out by utilizing machine accuracy from a reference position. For example, through-holes may be formed in series at a predetermined position from the reference position by pressing an object to be processed into contact with a member indicating a reference position. Also, a machining process may be applied to form a reference side surface after processing through-holes simultaneously in order to form each aperture in advance. In this case, the reference side surfaces are not necessarily processed simultaneously to be arranged on the same plane, and each reference side surface may be formed in advance with a predetermined amount of deviation. Formation and processing of the through-holes and processing of the reference side surfaces may be carried out by a continuous process. Here, continuous processing refers that, after an object to be processed is set on a workbench, the object to be processed is processed without being removed from the workbench.

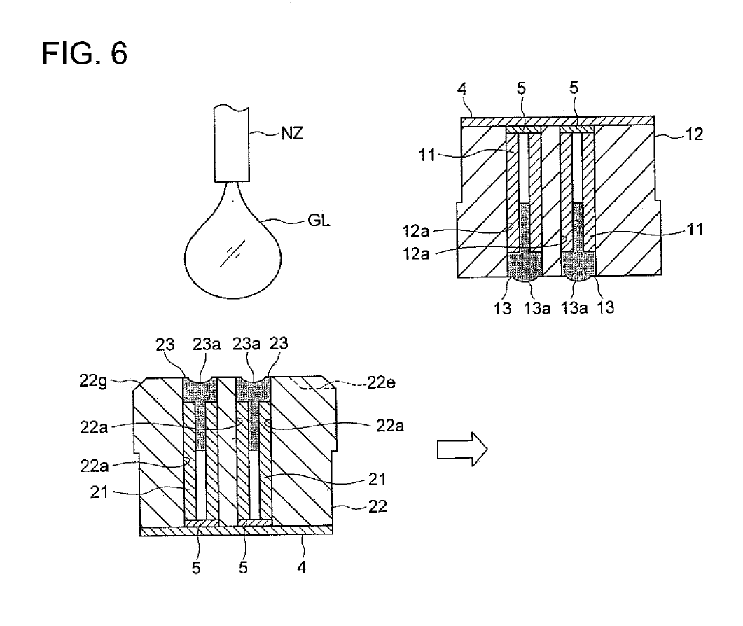

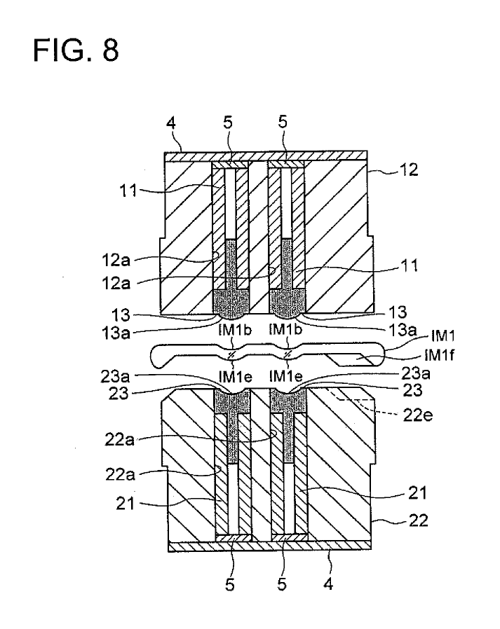

Next, formation of a lens unit will be described with reference to FIGS. 6 through 8. In FIGS. 6 through 8, the upper mold holder and the lower mold holder are omitted. It is to be noted that the first lens array IM1, which is the first glass lens array, is formed via the upper mold 12 and the upper mold 22, and the second lens array IM2, which is the second glass lens array, is formed via the upper mold 12′ and the upper mold 22′, here however, only the formation via the upper mold 12 and the lower mold 22 will be described.

As in the embodiment of the present invention, in the case in which a plurality of lens sections is formed collectively via a press molding between molds, any of the following methods may be adopted.

(1) A method in which a preform, having been formed in an approximate geometry, is arranged in each molding surface of a mold, and lens sections are formed by heating and cooling the preform.
(2) A method in which liquid molten glass is dropped from above on a molding surface, and lens sections are formed, without heating the molten glass, but by cooling the molten glass.
However, in a structure in which a glass lens array is formed as in the present embodiment, the aforementioned method of (2) is preferable, in which in particular a larger difference in central thickness between a lens section and a non-lens section (section which forms an area between a plurality of lenses or an end portion of an intermediary body) can be obtained, and further, a method in which a large glass drop, in other words, a molten glass drop of which the cubic volume is sufficient enough to fill at least two molding surfaces, is dropped is preferable rather than a method in which glass is dropped individually onto each molding surface. Also, regarding the drop position, a method in which a glass in dropped onto a position, having an equal distance from a plurality of molding surfaces to which filling is planned, is preferable. According to this structure, the differences in the time used for filling the glass drop in each molding surface may be reduced, and therefore, mischievous influences on the difference in shape and the optical properties of the lenses to be formed may be reduced. As a matter of course, although a similar effect may be obtained by dropping individual glass drop on each molding surface at the same time by considering the differences in the time, the reduction of glass droplet side may make the apparatus larger in size and more complicated by the structure, and therefore, the former case is more preferable.

In other words, in the former case of a large liquid drop, first the lower mold 22 having the core supporting members 21, having the cores 23 attached to an upper end, assembled in each of the four apertures 22a, is positioned below a platinum nozzle NZ which communicates with a storage section (not illustrated in the figure) in which hot-molten glass is stored, and a liquid drop of glass GL is dropped from the platinum nozzle NZ toward a position having an equal distance from plural molding surfaces onto the upper surface 22b. Thereby, because the viscosity of the glass GL is low, the dropped glass GL extends on the upper surface 22b, and enters into the transferring surfaces 23a readily and the geometry is transferred onto the glass GL, and also the geometries of the grooves 22e and the mark 22f are transferred accurately. Also, in the latter case in which a small liquid drop is dropped individually, a liquid drop of relatively large glass GL is separated into four small liquid drops after adjusting the amount of the drop by passing through four small holes, and is supplied substantially simultaneously onto the upper surface 22b. It is to be noted that in the case in which liquid molten glass is dropped, it is more likely that an air pocket is generated between each molding surface, and therefore, it is necessary to give adequate consideration to dropping conditions such as the volume to be dropped, and the like.

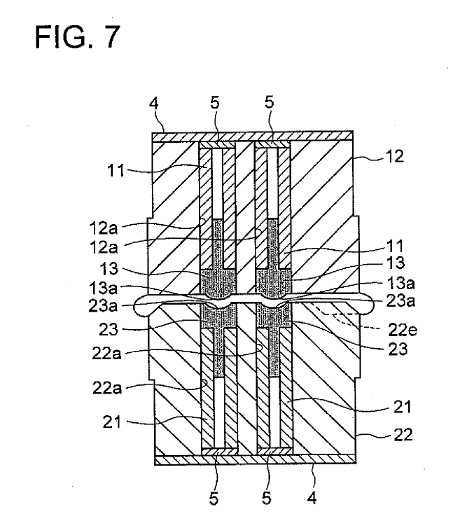

Next, before the glass GL is cooled down, by bringing the lower mold 22 close to a position where the lower mold 22 faces the upper mold 12 at the lower side of the upper mold 12 having the core supporting members 11, having the cores 13 attached to the lower end, assembled into each of the four apertures 12a, the lower mold 22 is aligned with the upper mold 12. At this time, by utilizing a guide (not illustrated in the figure) or the like, by making the reference side surfaces 12c and 12d of the upper mold 12, and the reference side surfaces 22c and 22d of the lower mold 22 (which are not illustrated in FIG. 7), used at the time of the aforementioned processing, be coplanar with each other, misalignment between the cores 13 and the cores 23 can be suppressed, and molding with a high degree of accuracy, in which the optical axes of either side of lens are aligned, can be carried out. Further as illustrated in FIG. 7, molding is carried out by arranging the upper mold 12 and the lower mold 22 close to each other. In this way, the geometry of the transferring surfaces 13a (convex shape here) of the cores 13 is transferred. It is to be noted that, as a shallow circular stepping portion is formed in the periphery of the cores 13, this is also transferred at the same time. At that time, the lower surface 12b of the upper mold 12 and the upper surface 22b of the lower mold 22 hold the glass GL, so as to be separated from each other by a predetermined distance, and cool down the glass GL. The glass GL becomes solidified in a state in which the glass GL covers the tapered portion 22g by flowing and drifting circumferentially.

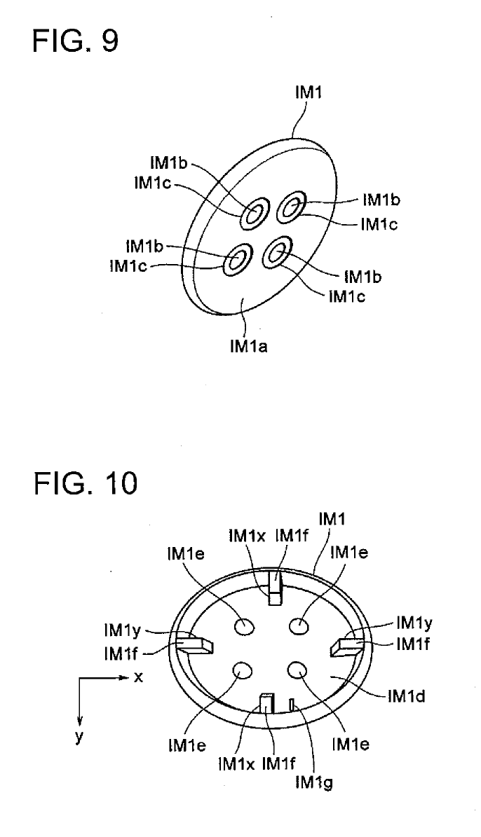

After that, the first glass lens array IM1 is formed by separating the upper mold 12 and the lower mold 22 and by removing the glass GL. FIG. 9 is a perspective view of the front side of the first glass lens array IM1, and FIG. 10 is a perspective view of the reverse side.

As illustrated in FIGS. 9 and 10, the first glass lens array IM1 is in a disk shape as a whole, and includes a surface IM1a which is a high precision plane surface having been transferred and formed via the lower surface 12b of the upper mold 12, four concave-shaped optical surfaces IM1b having been transferred and formed on the surface IM1a a via transferring surfaces 13a, and shallow circular grooves IM1c, having been transferred via the shallow circular stepping portion on its periphery. The shallow circular grooves IM1c are to store light shielding members SH, which will be described later.

Further, the first glass lens array IM1 includes: a reverse side IM1d which is a high precision plane surface having been transferred and formed via the upper surface 22b of the lower mold 22; four convex-shaped optical surfaces IM1e, four convex-shaped optical surfaces and a convex-shaped mark (a first mark), having been transferred and formed on the surface IM1d via transferring surfaces 23a, grooves 22e, and the mark 22f, respectively. The concave-shaped optical surfaces IM1b and convex-shaped optical surfaces IM1e constitute a first lens section L1. It is to be noted that convex-shaped optical surfaces IM1f is parallel to the optical axis of the first lens section L1, and is composed of a first reference surface portion IM1x opposed in the x direction, and a second reference surface portion IM1y opposed in they direction. The reverse side IM1d constitutes a first inclining reference surface, and a first shift reference surface is composed of the first reference surface portion IM1x and the second reference surface portion IM1y.

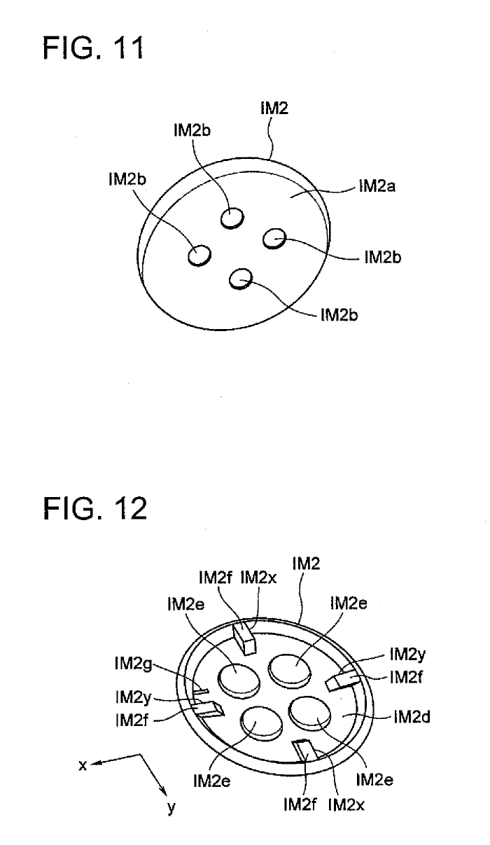

FIG. 11 is a perspective view of the front side of the second glass lens array IM2 which is formed via the upper mold 12′ and the lower mold 22′, and FIG. 12 is a perspective view of the reverse side. The second glass lens array IM2, having been formed in a similar fashion as the first glass lens array, as illustrated in FIGS. 11 and 12, is a disk shape as a whole, and includes a front surface IM2a which is a high precision plane surface having been transferred and formed via the lower surface 12b′ of the upper mold 12, and four concave-shaped optical surfaces IM2b having been transferred and formed on the front surface IM2a via transferring surfaces 13a′. It is to be noted that, with respect to the second glass lens array IM2, a shallow groove, on the periphery of the concave-shaped optical surface IM2b to be used to store the light shielding member SH, which will be described latter, is omitted, however, it may be arranged.

Also, the second glass lens array IM2 includes: the reverse surface IM2d which is a high precision plane surface having been transferred and formed via the upper surface 22b′ of the lower mold 22′; four convex-shaped optical surfaces IM2e, four convex-shaped optical surfaces IM2f, and a convex-shaped mark (a second mark) IM2g having been transferred and formed on the reverse surface IM2d via transferring surfaces 23a′, the grooves 22e′, and a mark 22f, respectively. The concave-shaped optical surface IM2b and the convex-shaped optical surfaces IM2e constitutes a second lens section L2. It is to be noted that the convex-shaped optical surfaces IM2f are parallel to the optical axis of the second lens section L2, and include third reference surface portions IM2x opposed in the x direction and fourth reference surface portions IM2y opposed in they direction. The reverse surface IM2d constitutes a second inclining reference surface, and the third reference surface portions IM2x and the fourth reference surface portions IM2y constitute a second shift reference surface. It is to be noted that, in a case in which, for the purpose of improving the formability of the first glass lens array IM1 and the second glass lens array IM2, or the like, the dimensions of flat portion of the aforementioned concave-shaped optical surface and convex-shaped optical surface are reduced, and the dimension of the flat portion (a part of this flat portion constitutes a flange which will be described later) of the periphery of these optical surfaces is increased, an increase of the thickness of the flat portion facilitates the molding. For example, in a case in which the total of projected area of the optical surface, viewed from the direction of optical axis, is smaller than the total area of the flat portion on the periphery of the optical surface, a better molding may be expected by making the thickness of the flat portion larger than the thickness in the optical surface.

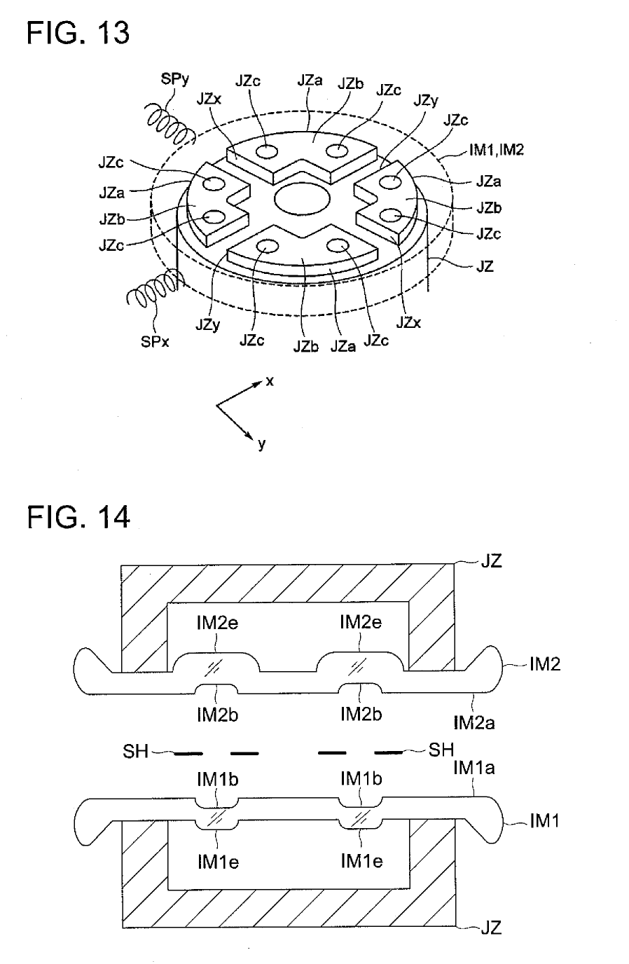

Next, by bonding the first glass lens array IM1 and the second glass lens array IM2 to each other, a process to form a third glass lens array IM3 will be described. FIG. 13 is a diagram illustrating a part of a jig JZ which holds the reverse side of the first glass lens array IM1 or the second glass lens array IM2. In FIG. 13, an end face of the jig JZ is cut into a cruciform shape. In other words, on the end face of the jig JZ, four land sections JZa having an equal height are formed, and their upper surfaces JZb are each a plane, and also on the upper surfaces JZb, suction holes JZc communicated with a negative-pressure source (not illustrated in the figure) are formed. The land sections JZa include, in the cut portion, reference holding surfaces JZx opposed in the x direction, and reference holding surfaces JZy opposed in they direction. Further, the jig JZ includes a spring SPx (illustrated simply) which biases a glass lens array, to be held, in the x direction, and a spring SPy (illustrated simply) which biases a glass lens array in the y direction.

Here, the second glass lens array IM2 is held in a vertical direction against gravity. By turning the jig JZ upside down, while sucking air from the suction holes JZc, the upper surfaces JZb of the land sections JZa are pressed into contact with the reverse surface IM2d of the second glass lens array IM2. At this time, as the upper surfaces JZb of the land sections JZa of the jig JZ is attached firmly to the reverse surface IM2d, a tilt of the second glass array IM2 with respect to the jig JZ can be set accurately. Also, while biased via the spring SPx, the reference holding surfaces JZx of the land sections JZa are brought into contact with the third reference surface portions IM2x, and whilebiased via the spring Spy, the reference holding surfaces JZy are brought into contact with the fourth reference surfaces IM2y. At this time, the mark IM2g becomes an index indicating which one is the position of the third reference surface portions IM2x or the fourth reference surface portions IM2y. Thereby, positioning of the second glass lens away IM2 in the x and y directions with respect to the jig JZ can be carried out accurately. Because the third reference surface portions IM2x and the fourth reference surface portions IM2y are formed on both of the opposite sides of the lens section, high-precision positioning can be carried out by utilizing the long span effectively.

In a similar fashion, the reverse surface Im1d of the first glass lens array IM1 can be held accurately in an inclining direction and in the x and y directions via another jig JZ. In other words, as the upper surfaces JZb of the land sections JZa of the jig JZ are brought into contact with the reverse surface IMld firmly, the tilt of the first glass lens array IM1 with respect to the jig JZ can be set accurately. Also, while biased via the spring SPx, the reference holding surfaces JZx of the land sections JZa are brought into contact with the first reference surface portion IM1x, and while biased via the spring SPy, the reference holding surfaces JZy are brought into contact with the second reference surface portion IM1y. At that time, the mark (the first mark) IM1g becomes an index indicating which one is the position of the first reference surface portion IM1x or the second reference surface portion IM1y. As described above, by determining the relative positioning of the two jigs JZ accurately, the positioning of the first glass lens array IM1 and the second glass lens array IM2 can be carried out accurately. Here, because the coordinates of the apertures 12a, 22; 12a′, and 22a′ of the upper molds 12 and 12′ and the lower molds 22 and 22′ in the x and y directions coincide, the optical axes of the first lens section L1 and the second lens section L2 coincide to each other accurately. In other words, the positioning of the first glass lens array IM1 and the second glass lens array IM2 is carried out by using the first and second reference surfaces having been formed together with a lens section via a mold in which a core, which includes molding surfaces to form each lens sections of an upper mold and a lower mold, has been positioned accurately, and having a high-precision relative positioning with respect to the mentioned lens section, and therefore, the mentioned positioning can be carried out accurately, and as a result, a high-precision third glass lens array can be obtained in which the optical axes of each lens corresponding to a first and a second lens array coincide.

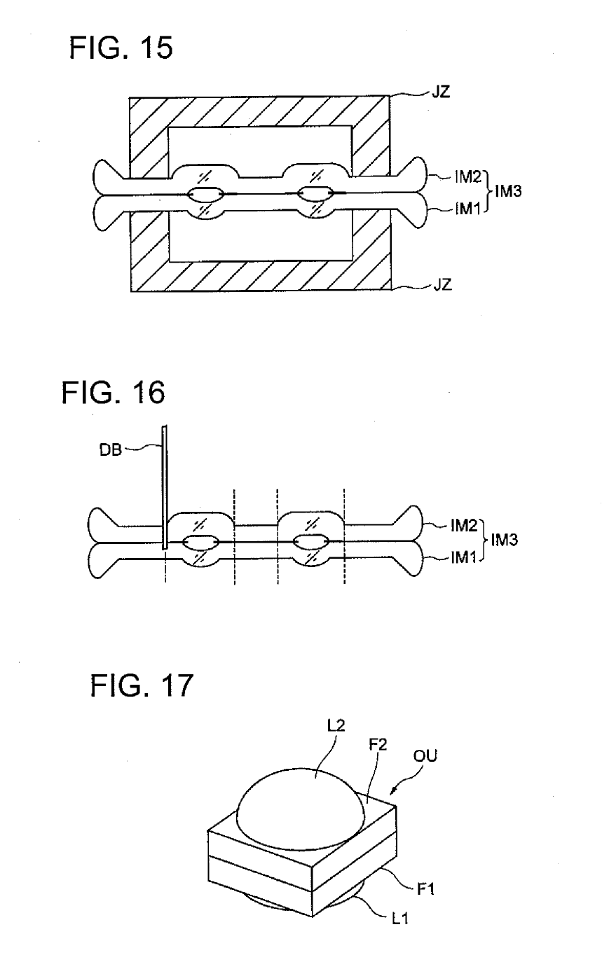

Further as illustrated in FIG. 14, by arranging the surface IM1a of the first glass lens array IM1 being held accurately via the jig JZ and the surface IM2a of the second glass lens array IM2a being held accurately via the other jig JZ to face each other in this way, and after arranging four light shielding members SH, having a doughnut-plate shape between the two surfaces, an adhesive is applied to at least either one of the surfaces IM1a and IM2a of the first glass lens array IM1 and the second glass lens array IM2, and then as illustrated in FIG. 15, the jigs are brought relatively close to each other so as to bring the surfaces IM1a and IM2a into firmly contact, while awaiting solidification of the adhesive. As the adhesive solidifies, the third glass lens array IM3 is formed in which the light shielding members SH are fixed to the circular grooves IM1c, and the first glass lens array IM1 and the second glass lens array IM2 are bonded to each other.

After that, by terminating the suction of the upper jig JZ and by separating the jig JZ, the third glass lens array IM3 having been held by the lower jig JZ can be removed, and therefore, as illustrated in FIG. 16, by cutting the third glass lens array IM3 by a dicing blade DB, a lens unit OU as illustrated in FIG. 17 can be obtained. The lens unit OU is composed of the first lens section L1, the second lens section L2, a rectangular-plate-shaped flange F1 (constituted by a part of the surfaces IM1a and IM1d of the first glass lens array IM1) in the periphery of the first lens section L1, a rectangular-plate-shaped flange F2 (constituted by a part of the surfaces IM2a and IM2d of the first glass lens array IM2) on the periphery of the second lens section L2, and the light shield members SH arranged between the first lens section L1 and the second lens section L2.

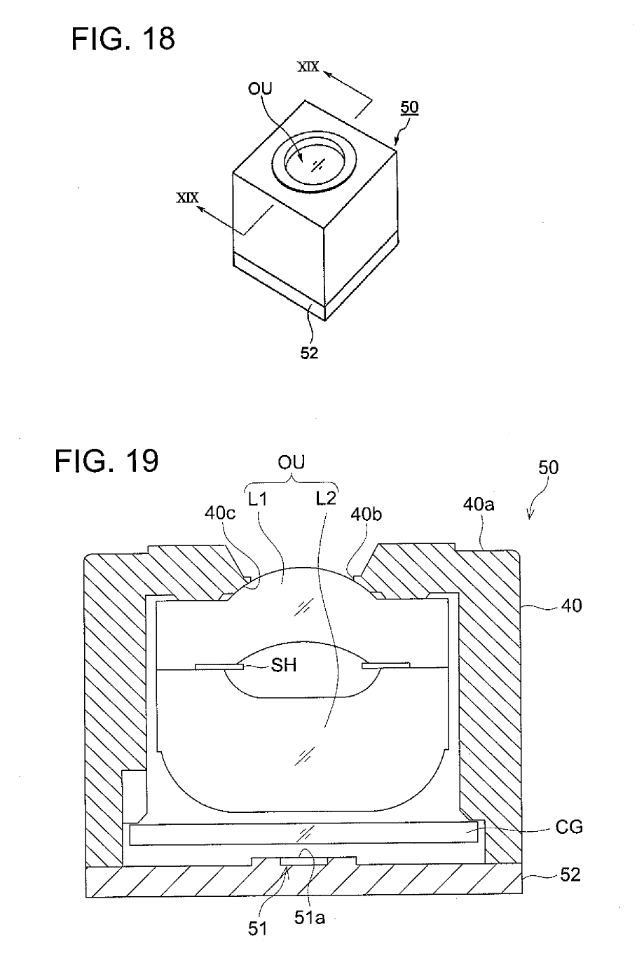

FIG. 18 is a perspective view of the imaging device 50 using the lens unit according to the present embodiment, and FIG. 19 is a cross-sectional view of the configuration of FIG. 18 cut along the arrow XIX-XIX line and viewed in the direction of the arrows. As illustrated in FIG. 19, the imaging device 50 includes a CMOS type image sensor 51 as a solid-state imaging element having a photoelectric conversion section 51a, the lens unit OU to capture a subject image on a photoelectric conversion section 51a of the image sensor 51, a substrate 52 which holds the image sensor 51 and includes terminals for external connection (not illustrated in the figure) for sending and receiving electrical signals, and these are integrally formed in one body.

In the aforementioned image sensor 51, formed is a photoelectric conversion section 51a serving as a light receiving section having pixels (photoelectric conversion elements) arranged as a two-dimensional arrangement on the central portion on a plane on the light receiving side of the image sensor 51, and is connected to a signal processing circuit which is not illustrated in the figure. The signal processing circuit of this kind is composed of a drive circuit section that drives each pixel in succession to obtain signal electric charges, an A/D conversion section that converts each signal electric charge into a digital signal, and a signal processing section that forms an image signal output by using this digital signal, and the like. Also, there are arranged a number of pads (not illustrated in the figure) around the outer edge of the plane on the light receiving side of the image sensor 51 and these pads are connected to substrate 52 through wires which are not illustrated in the figure. The image sensor 51 converts signal electric charge coming from the photoelectric conversion section 51a into image signals such as digital YUV signal, and outputs these signals to prescribed circuits on substrate 52 through wires (not illustrated in the figure). In this case, Y represents luminance signals, U (=R−Y) represents color difference signals between red and luminance signals, and V (=B−Y) represents color difference signals between blue and luminance signals. It is to be noted that, the image sensor is not limited to the aforementioned CMOS type image sensor, and other sensors such as a CCD or the like, may also be used.

The substrate 52 which supports the image sensor 51 is connected to the image sensor 51 through wires, which are not illustrated, so as to be able to conduct communication.

The substrate 52 is connected with external circuits (for example, control circuits included in a higher-level device of the mobile terminal device in which the image pickup device is mounted) through the terminals for external connection so that it becomes possible to receive voltage and clock signals to chive the image sensor 51 from an external circuit, and to output digital YUV signals to an external circuit.

The upper part of the image sensor 51 is sealed by a cover glass which is not illustrated in the figure, and an IR cut filter is arranged above the image sensor 51 and below the second lens section L2. A lens frame 40 having a hollow rectangular cylindrical-shape has an opening at the lower portion, while the upper portion is covered by a flange section 40a. An aperture 40b is formed in the center of the flange section 40a. The lens unit OU is arranged inside the lens frame 40.

The lens unit OU includes, in order from an object side thereof an aperture stop for which the aperture edge portion of the lens frame functions, the first lens section L1, the light shield member SH for shielding unnecessary light, and the second lens section L2. As described above, the first lens section L1 and the second lens section L2 are made of glass, and therefore, have excellent optical properties. In the present embodiment, positioning regulation is carried out such that a taper-shaped inner periphery 40c of the aperture 40b is brought into contact with the optical surface of the first lens section L1 or the curved surface (however, not including the flange surface) formed by extending the curved surface in the case in which the aforesaid lens becomes out of alignment. In this way, by simply placing the lens frame 40 onto the substrate 52, a light receiving surface of the image sensor 51 can be positioned accurately at the focal point of the lens unit OU.

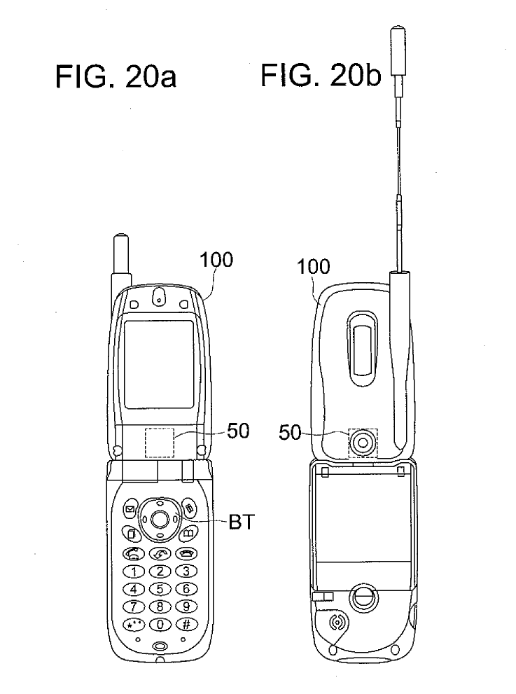

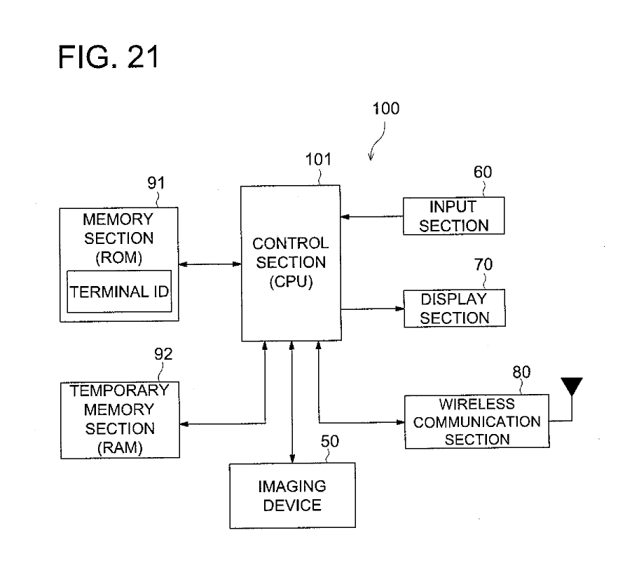

Next, an example of the use of the imaging device 50 will be described. FIGS. 20a and 20b are each a diagram illustrating a state in which the imaging device 50 is incorporated in a cellular phone 100, which serves as a mobile terminal representing a digital device. Also, FIG. 21 is a control block diagram of the cellular phone 100.

For example, the imaging device 50 is arranged at a position corresponding to the lower portion of a liquid crystal display section of the cellular phone 100 in such a way that the object side end surface of the lens unit 10 is provided to the back surface (assuming that the liquid crystal display side is the front surface) of the cellular phone 100.

The terminals for external connection (not illustrated in the figure) of the imaging device 50 are connected with a control section 101 of the cellular phone 100, and image signals such as luminance signals and color difference signals are output to the control section 101 side.

On the other hand, as shown in FIG. 4, the cellular phone 100 includes: the control section (CPU) 101 to control overall each section and to execute programs in accordance with each processing; an input section 60 to input numbers by a key, a display section 70 to display photographed images, video pictures, and the like; a wireless communication section 80 to realize various kinds of information communication between the cellular phone 100 and external servers; a memory section (ROM) 91 to memorize system programs of the cellular phone 100, various processing programs and required various data, such as a Terminal ID; and a temporary memory section (RAM) 92 used as working areas to temporarily store various processing programs executed by the control section 101, data or processing data, imaging data by the imaging device 50.

When a photographer who grips the cellular phone 100 faces the lens unit of the imaging device 50 toward a photographic object, image signals of a still image or a motion picture are picked up into the image sensor 51. That is, when the photographer presses a button BT illustrated in FIG. 20 at a desired photo opportunity, a shutter is released such that image signals are picked up into the imaging device 50. The image signals input from the imaging device 50 are transmitted to a control system of the cellular phone 100, and then are memorized in the memory section 92, or displayed on the display section 70, and further, the image signals may be transmitted as picture information outside through the wireless communication section 80.

### INDUSTRIAL APPLICABILITY

The present invention is not limited to the examples described in the specification, and it is clear, for those having ordinary skill in the art in the present field, from the examples and spirits described in the present specification, that the invention includes other examples and variations. For example, by creating a concave-portion on a surface of the first glass lens array by using a mold, and by creating a convex-portion on a surface of the second glass lens array, a third glass lens array may be obtained by bonding the first glass lens array and the second glass lens array so as to fix the concave-portion and the convex-portion together.

### DESCRIPTION OF THE SYMBOLS

1 Core supporting member
2 Mold sleeve
2a Aperture
2b Small-diameter portion
2c Through-hole
3 Core
3a Molding transfer surface
3b Head section
3c Shaft section
4 Bottom plate
5 Disk-shaped spacer
11 Core supporting member
12 Core supporting member
12 Upper mold
12a Aperture
12b Lower surface
12c Reference side surface
12d Reference side surface
13 Core
13a Transfer surface
13d Circular step portion
19 Upper holder
21 Core supporting member
22 Core supporting member
22 Lower mold
22a Aperture
22b Upper surface
22c Reference side surface
22e Groove
22f Mark
22g Tapered portion
22x Reference surface
22y Reference surface
23 Core
23a Transfer surface
29 Lower holder
40 Lens frame
40a Flange section
40b Aperture
40c Inner periphery
50 Imaging device
51 Image sensor
51a Photoelectric conversion section
52 Substrate
60 Input section
70 Display section
80 Wireless communication section
92 Memory section
100 Cellular phone
101 Control section
BH Bolt-hole
BT Button
CG Cover glass
DB Dicing blade
F1 Rectangular-plate-shaped spacer
F2 Rectangular-plate-shaped flange
IM1 First glass lens array
IM2 Second glass lens array
IM3 Third glass lens array
JZ Jig
L1 First lens section
L2 Second lens section
MG Magnet
NZ Platinum nozzle
OU Lens unit
SH Light shielding member
SPx Spring
SPy Spring

1. A method for manufacturing a lens unit, the method comprising the steps of:
forming a first glass lens array comprising a plurality of first lens sections and first positioning reference surfaces, having been formed in a predetermined arrangement, via glass forming by arranging a glass material between a first set of assembled molds and by clamping said first set of assembled molds;
forming a second glass lens array comprising a plurality of second lens sections and second positioning reference surfaces, having been formed in a predetermined arrangement, via glass forming by arranging a glass material between a second set of assembled molds and by clamping said second set of assembled molds;
forming a third glass lens array by stacking and bonding said first glass lens array and said second glass array to each other in such a manner that an optical axis of each lens section of said first glass lens array and said second glass lens array coincide, by using said first positioning reference surface and said second positioning reference surface; and
cutting said third glass lens array in each lens unit which comprises at least each one of said first lens section and said second lens section.

2. The method for manufacturing a lens unit described in claim 1, wherein:
said first positioning reference surface is formed parallel to an optical axis of said first lens section and consists of a first reference surface section and a second reference surface section in mutually intersecting directions; and
said second positioning reference surface is formed parallel to an optical axis of said second lens section and consists of a third reference surface section and a fourth reference surface section in mutually intersecting directions.

3. The method for manufacturing a lens unit described in claim 1, wherein:
said first positioning reference surface comprises a first inclination reference surface section perpendicular to the optical axis of said first lens section; and
said second positioning reference surface comprises a second inclination reference surface section perpendicular to the optical axis of said second lens section.

4. The method for manufacturing a lens unit described in claim 1, wherein the step for bonding said first glass lens array and said second glass array to each other comprises the step of:
in a state in which a biasing force is being applied to said first positioning reference surface by placing said first glass lens array downwardly in a vertical direction, approximating said second glass lens array, which is maintained upwardly in the vertical direction, to said second positioning reference surface in a state in which a biasing force is being applied to said second positioning reference surface.

5. The method for manufacturing a lens unit described in claim 1, wherein:
said first glass lens array comprises a first mark indicating said first positioning reference surface; and,
said second glass lens array comprises a second mark indicating said second positioning reference surface.

6. The method for manufacturing a lens unit described in claim 1, wherein the step for forming at least either one of said first glass lens array or said second glass array comprises the step of:
carrying out formation after causing a molten glass material to be dropped from above in a vertical direction onto a lower mold of a set of assembled mode of at least either one of said first set of assembled mold or said second set of assembled mold

7. An imaging device comprising:
a lens unit manufactured by a manufacturing method described in claim 1; and
a lens frame which encloses said lens unit,
wherein a lens section of said lens unit or a surface formed by extending the lens section is positioned with respect to the lens frame.

8. A method for manufacturing a first upper mold, a first lower mold, a second upper mold, and a second lower mold,
using the first upper mold comprising: a first upper mold sleeve into which a plurality of cylindrical through-holes is formed, and which comprises a first side surface portion parallel to said through-holes; and a plurality of first upper mold core members each of which is inserted into said through-holes, and each of which comprises a transferring surface at one end for forming a lens section;
using the first lower mold comprising: a first lower mold sleeve into which a plurality of cylindrical through-holes is formed, and which comprises a second side surface portion parallel to said through-holes; and a plurality of first lower mold core members each of which is inserted into said through-holes, and each of which comprises a transferring surface at one end for forming a lens section;
using the second upper mold comprising: a second upper mold sleeve into which a plurality of cylindrical through-holes is formed, and comprises a third side surface portion parallel to said through-holes; and a plurality of second upper mold core members each of which is inserted into said through-holes, and each of which comprises a transferring surface at one end for forming a lens section;
using the second lower mold comprising: a second lower mold sleeve into which each a plurality of cylindrical through-holes is formed, and comprises a fourth side surface portion parallel to said through-holes; and a plurality of second lower mold core members each of which is inserted into said through-holes, and each of which comprises a transferring surface at one end for forming a lens section;
forming a first glass lens array in which a plurality of glass lens sections and flange sections are integrally formed by arranging a glass material between said first upper mold and said first lower mold and by clamping said first upper and lower molds;
forming a second glass lens array in which a plurality of glass lens sections and flange sections are integrally formed by arranging a glass material between said second upper mold and said second lower mold and by clamping said second upper and lower molds; and
forming a glass lens array layered body by stacking and bonding said first glass lens array and said second glass lens array;
the method for manufacturing said first upper mold, said first lower mold, said second upper mold, and said second lower mold, the method comprising the steps of:
stacking said first upper mold, said first lower mold, said second upper mold, and said second lower mold; and
processing each through-hole of said first upper mold, said first lower mold, said second upper mold, and said second lower mold simultaneously via a machining process.

9. The method for manufacturing the molds described in claim 8, wherein formation and processing of said first side surface portion, said second side surface portion, said third side surface portion, and said fourth side surface portion are carried out by a machining process together with the simultaneous processing of said through-holes.

10. A mold for molding a glass lens array in which a plurality of lens sections and flange sections are integrally formed, the mold for molding comprising:
an upper mold arranged above in a vertical direction comprising: an upper mold sleeve into which a plurality of cylindrical through-holes is formed; and a plurality of upper mold core members each of which is inserted into said plurality of through-holes, each of which comprises a transferring surface at one end for forming a lens section; and
a lower mold arranged below in the vertical direction in which a transferring surface faces said upper mold,
wherein a glass lens array, in which a plurality of glass lens sections and flange sections are integrally formed, is formed by arranging a glass material between said upper mold and said lower mold and by clamping said upper mold and said lower mold.

11. The mold for molding described in claim 10, wherein, a diameter of through-holes of said upper mold is constituted so as to have an identical diameter entirely from an upper side to a lower side, and comprising a holding section for holding said upper mold core members in a vertical direction against gravity with respect to said upper mold sleeve.

12. The mold for molding described in claim 11, wherein, said holding section is a magnet, and at least a part of said upper mold core members is composed of a magnetic material.

13. The mold for molding described in claim 10, wherein said lower mold comprises: a lower mold sleeve into which a cylindrical through-hole is formed; and a plurality of lower mold core members having a transferring surface at one end for forming a lens section, wherein at least one of said upper mold core members or said lower mold core members is arranged so that an amount of protrusion is adjustable by using a spacer with respect to at least either one of said upper mold sleeve or said lower mold sleeve.

14. A method for molding a glass lens array for forming a glass lens array in which a flange section and a plurality of lens sections are integrally formed by arranging a glass material between an upper mold and a lower mold arranged in a vertical direction and by clamping said upper mold and lower mold, the method comprising steps of:
preparing said lower mold, arranged below in the vertical direction, having a plurality of transferring surfaces corresponding to lens surfaces of said plurality of lens sections;
dropping simultaneously from above a necessary amount of molten glass to form at least two of said lens sections onto said lower mold; and
arranging said upper mold with respect to said lower mold onto which the molten glass has been dropped, and clamping said upper mold and said lower mold.

15. The method for molding a glass lens array described in claim 14, wherein the molten glass to be dropped in said step is dropped onto a position having an equal distance from a plurality of transferring surfaces for forming said lens sections.
